(19) United States
(12) Patent Application Publication
(10) Pub. No.: US 2008/0128946 A1
(43) Pub. Date: Jun. 5, 2008

(54) Mold assembly for lightweight pistons

(76) Inventors: David J. Boye, Menominee, MI (US); Patrick A. Lemire, Menominee, MI (US)

Correspondence Address: BUTZEL LONG, 350 SOUTH MAIN STREET, SUITE 300, ANN ARBOR, MI, 48104, US

(21) Appl. No.: 11/054,804

(22) Filed: Feb. 10, 2005

(51) Int. Cl. B29C 57/00

(52) U.S. Cl. 264/296; 425/140

(57) ABSTRACT

A mold assembly for molding lightweight pistons having weight reduction pockets formed in outer surfaces thereof above pin holes. The weight reduction pockets are formed using window structures that are movable upward and downward at inclined angles. The movement of the windows is coordinated with the movement of pin members that are used to form the pin holes, which pin members pass through the windows. The movement of the windows and pin members is controlled by a cam assembly that uses an elongate cam element that moves horizontally and affects upward and downward movement of the windows.

### TECHNICAL FIELD

The present invention relates to piston mold assemblies for molding pistons with weight reduction pockets above pin holes formed in the pistons. More specifically, the present invention relates to a piston mold assembly that includes a cam assembly which operates to open and close the piston mold assembly.

### BACKGROUND

The demand for reduction of fuel consumption in internal combustion engines has resulted in the development of lightweight, high performance pistons. Such pistons have to withstand high loads, pressures and temperatures and be structurally and mechanical stable while at the same time, provide desired weight reduction.

In the past, piston weight reduction was achieved by providing a cavity in the area beneath the piston crown, i.e. on the side of the piston crown remote from the combustion chamber. In particular it is known to provide weight reduction cavities above the pin holes in the sides of the piston heads. However, these areas are not readily accessible, so that it becomes a challenge to form such weight reduction cavities during the fabrication of pistons.

The present invention provides a modified single cavity mold assembly having a unique cam system that can be used to form weight reduction cavities above the pin holes of a piston during a molding process.

### DISCLOSURE OF THE INVENTION

According to various features, characteristics and embodiments of the present invention which will become apparent as the description thereof proceeds, the present invention provides a piston mold assembly that includes:

a base;

a core extending upward from the base for shaping an interior of a piston;

a set of mold segments that are horizontally movable with respect to the core so as to converge upon the core to define a mold cavity that forms sides of a piston;

a set of pin members that are horizontally movable with respect to the core so as to converge upon the core to form pin holes of a piston;

a set of windows which are movable upward and downward at inclined angles with respect to the core so as to form weight reduction pockets in opposite outer sides of a piston above pin hole formed in the piston; and

a cam assembly that coordinates the movement of the pin members and the windows so that after a piston is molded, downward movement of the windows is delayed until horizontal movement of the pin members has occurred.

The set of pin members are configured to move horizontally through the windows. The cam assembly includes elongate cam elements that are movable horizontally together with the pin members. This simultaneous movement can be achieved by a pair of horizontally movable holders to which the pin members and elongate cam elements are coupled for horizontal movement therewith.

Lower portions of the windows are provided with cam followers. The elongate cam elements have curved portions which are configured to push against the cam followers and thereby move the windows downward as the elongate cam elements move horizontally outward with respect to the windows.

The lower portions of the windows further include horizontal surfaces above the cam followers. The curved portions of the elongate cam elements are configured to push against the horizontal surfaces of the windows and thereby move the windows upward as the elongate cam elements move horizontally inward with respect to the windows.

A set of cam plates are held in a fixed position with respect to base. The cam plates are configured so that inward portions of the elongate cam elements brace the windows upward against surfaces of the cam plates.

The windows can include guide structures on opposite sides that guide the upward and downward movement of the windows. The upper portions of the windows are configured to define the shape of the weight reduction pockets and to define the shape of a lower lip formed on a piston head of a piston formed in the mold assembly.

The present invention further provides a method of molding a piston which comprises the steps of:

a) providing a piston mold assembly that involves:
i) a base;
ii) a core extending upward from the base for shaping an interior of a piston;
iii) a set of mold segments that are horizontally movable with respect to the core so as to converge upon the core to define a mold cavity that forms sides of a piston;
iv) a set of pin members that are horizontally movable with respect to the core so as to converge upon the core to form pin holes of a piston;
v) a set of windows which are movable upward and downward at inclined angles with respect to the core so as to form weight reduction pockets in opposite sides of a piston above pin hole formed in the piston; and
vi) a cam assembly that coordinates the movement of the pin members and the windows so that after a piston is molded downward movement of the windows is delayed until horizontal movement of the pin members has occurred;

b) positioning the mold segments, pin members and windows into position in the mold assembly to produce a mold cavity;

c) delivering molten metal into the mold cavity to mold a piston therein and thereafter;

d) moving the pin members outward from the mold;

e) moving the windows downward;

f) moving the mold segments outward; and

g) removing the cast piston from the mold assembly.

When a piston is removed during this method, step d) is performed before step e). Moreover, the pin members continue to move outward as the windows move downward. When the mold assembly elements are moved into a closed position to form a mold cavity, steps d) and e) are reversed.

The present invention further provides an improvement for a piston mold assemblies configured to mold a pistons therein that have a set of retractable pin members for forming pin holes in the cast piston and a set of windows for forming weight reduction pockets over the pin holes, the improvement involving the inclusion of a cam assembly that coordinates horizontal movement of the pin members and upward and downward movement of the windows at inclined angles so as to form weight reduction pockets in opposite sides of the cast piston above pin holes formed in the piston.

The improvement further includes providing a cam assembly that coordinates the movement of the pin members and the windows so that after the piston is molded downward movement of the windows is delayed until horizontal movement of the pin members has occurred.

### BRIEF DESCRIPTION OF DRAWINGS

The present invention will be described with reference to the attached drawings which are given as non-limiting examples only, in which:

FIG. 1 is a cross-sectional view of a piston that can be produced using a piston mold assembly according to the present invention.

FIG. 2 is a cross-sectional view of a piston mold assembly according to one embodiment of the present invention.

FIGS. 3A-3C are a series of cross-sectional views which depict the process by which the pins and the windows are moved in a mold assembly according to one embodiment of the present invention.

FIG. 4 is top planar view of a window structure used to form a weight reduction pocket in a piston according to one embodiment of the present invention.

FIGS. 5A-5C are a series of cross-sectional views which depict the manner in which the cam assembly cooperates to move the pins and the windows from a mold assembly according to one embodiment of the present invention.

FIG. 6 is a top perspective view of a sectioned piston mold assembly according to one embodiment of the resent invention.

### BEST MODE FOR CARRYING OUT THE INVENTION

The present invention is directed to mold assemblies that are used for molding pistons with weight reduction pockets and pistons produced from such mold assemblies. The piston mold assemblies of the present invention are single cavity molds that are designed and configured to produce lightweight pistons that require minimum post-molding processing. The mold assemblies can be based on conventional mold machines which would require according to the present invention, minimum modification to produce the lightweight pistons. No retro kit is needed to modify an existing or conventional mold machine for use according to the present invention. Any necessary modification is accomplished by simple mold tooling and saddle modifications. The piston mold assemblies of the present invention include cam systems that are designed to produce sufficient force to remove inclined windows from a cast piston and require only minimal force in the horizontal direction so that springs can be used to hold mold blocks in a closed position until the inclined windows clear the cast piston.

The lightweight pistons of the present invention are configured to include weight reduction pockets above the pin holes on opposite outer sides of the pistons. According to the present invention, these weight reduction pockets are formed by the use of movable mold pieces (referred herein to as “windows”). Since the direction of travel for conventional mold designs is horizontal in the area where the weight reduction pockets of the present invention are provided, such weight reduction pockets cannot be produced using conventional mold assembly designs.

The mold assembly of the present invention was designed by first determining, from the geometry of a piston structure having desired weight reduction pockets, how to configure and manipulate the various structural elements of the mold assembly to enable removal of the cast lightweight piston.

It was ultimately determined that the windows used to mold the weight reduction pockets had to be moved downward to clear the weight reduction pockets using horizontal force applied to pins used to form pin holes in the cast piston. Moreover, depending on the configuration of the weight reduction pockets, the windows had to be moved downward at an angle. Once the windows were moved downward to provide sufficient clearance, the cast lightweight pistons are removed from the mold assembly by removing the side blocks of the mold assembly a conventional manner.

According to the present invention, the movement of the windows used to form the weight reduction pockets is coordinated with the movement of the pins that are used to form the pin holes in the pistons. In this regard, it was determined during the course of the present invention that since the pins used to form the pin holes have to travel horizontally though the windows, the pins had to be withdrawn from the windows before the windows could move downward to clear the weight reduction pockets that are formed in the cast piston.

The movement of the pins and the windows is coordinated by means of a cam assembly. The cam assembly includes an elongate cam element that moves horizontally and is configured to cooperate with cam surfaces provided on the windows to cause the windows to move upward when the elongate cam element is moved inward and to move downward when the elongate cam element is moved outward. In addition the cam assembly includes a cam plate near the base of the mold assembly which cooperates with the elongate cam element to brace the windows in their upper or closed positions.

The elongate cam element can be coupled to the pin members to move horizontally therewith. In one embodiment a pin and cam holder is provided which couples the elongate cam elements to the pin members.

In the following description which is made with reference to the attached non-limiting drawings, the same reference numerals have been used to identify similar elements when possible to simplify the description.

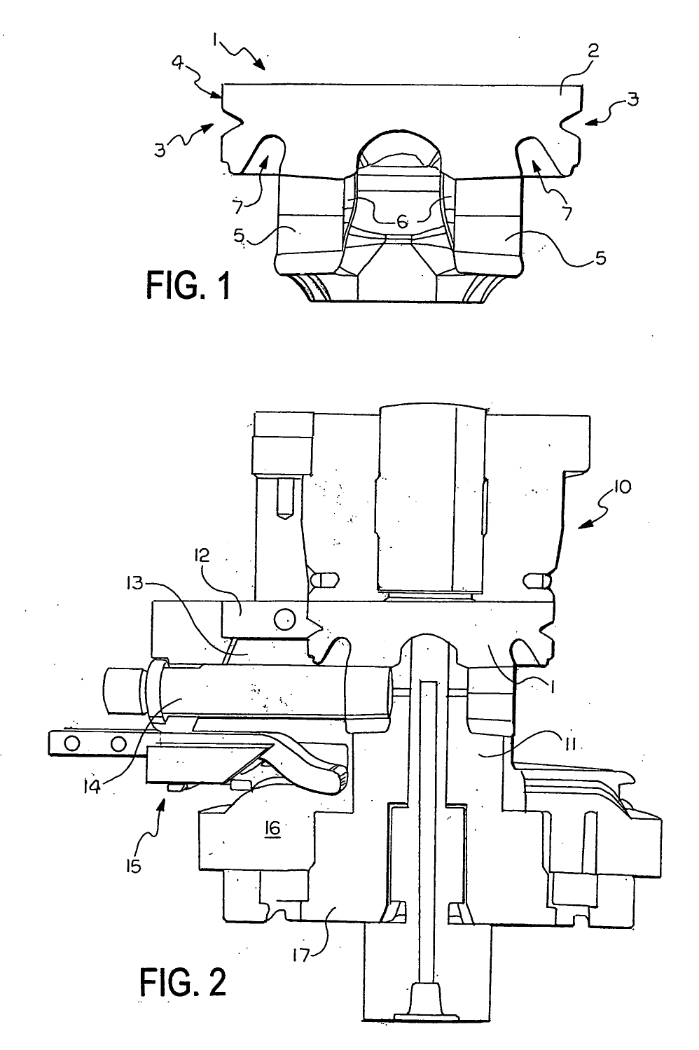

FIG. 1 is a cross-sectional view of a piston according to one embodiment of the present invention. The piston 1 depicted in FIG. 1 includes a piston head 2 having piston ring groves 3 formed in a peripheral surface 4, a pair of pin holes 5, a junction area 6 that connects the pin holes 5 to the piston head 2 and weight reduction pockets 7 formed in the piston head 2 above the pin holes 5. Although not shown, the top 8 of the piston head 2 can have a contoured crown shape of any conventional design.

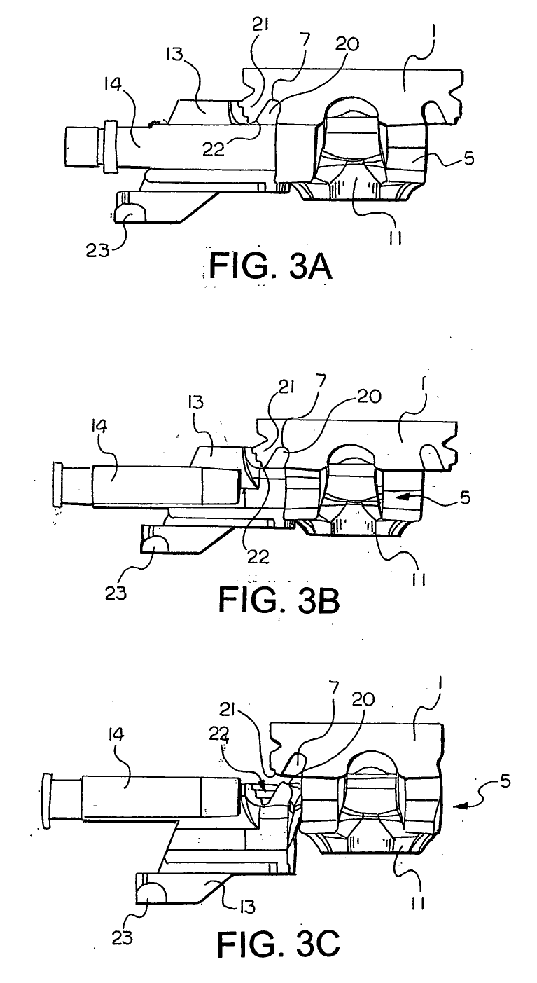

FIG. 2 is a cross-sectional view of a piston mold assembly according to one embodiment of the present invention. In FIG. 2 elements on the right-hand side which are similar to those on the left-hand side have been deleted to simplify the illustration. The piston mold assembly depicted in FIG. 2 includes a dome 10 which defines the top of piston 1 cast therein, a core 11 which defines the bottom of a piston 1 cast therein, semi-annular upper side blocks 12, windows 13, pins 14 and a cam assembly 15 which coordinates the movement of the pins 14 and windows 13. The dome 10 and/or core 11 are provided with mechanisms by which they can be released from a piston 1 cast in the mold assembly as is generally known in the art of piston mold assemblies. The upper side blocks 12, windows 13 and pins 14 are movable in a coordinated manner controlled in part by the cam assembly 15 as will be discussed in detail below. The cam assembly 14 includes a cam plate 16 which can be supported on the base 17 of the core 11 as depicted.

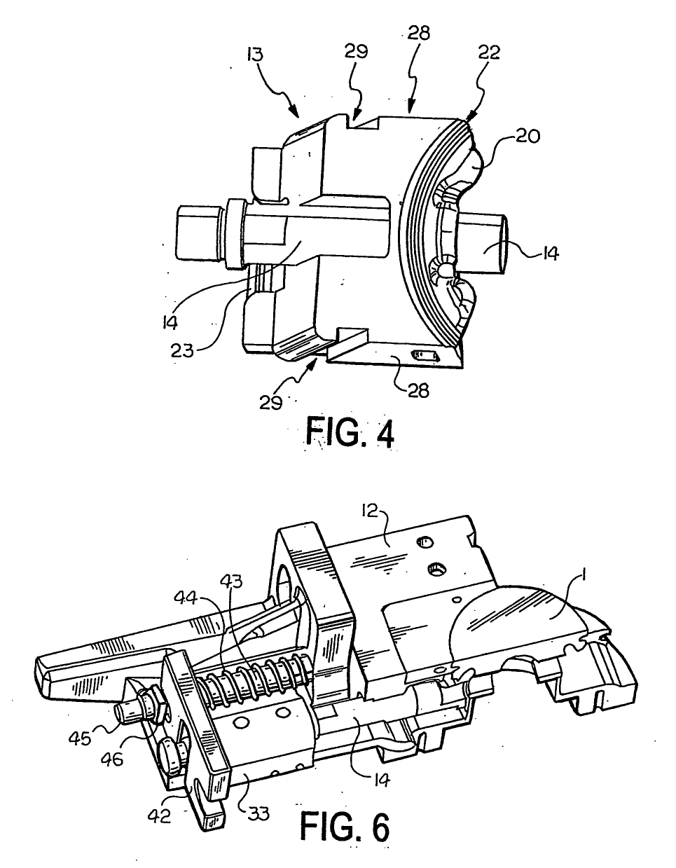

FIGS. 3A-3C are a series of cross-sectional views which depict the process by which the pins and the windows are moved in a mold assembly according to one embodiment of the present invention. FIG. 3A depicts pin 14 and window 13 in their fully closed positions in the piston mold assembly. In the depicted position the forward end of the pin 14 abuts and engages a receiving surface provided on the core 11. The window 13 includes an upper configuration that forms both pocket 7 and the outer side edge of the piston head 2. This configuration includes a curved projection 20 that defines and forms the weight reduction pocket 7 and an adjacent recess 22 that defines and forms a lower lip 21 on the head of the cast piston 1.

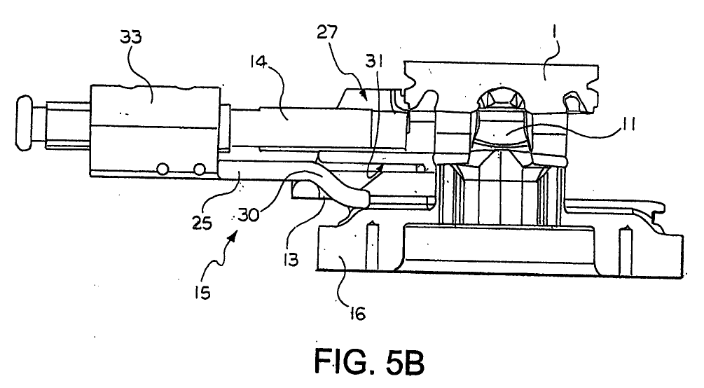

The lower portion of window 13 includes a cam follower 23 that is positioned beneath the pin 14 and cooperates with a movable elongate cam element 25 (See FIGS. 5A-5C), to cause the window 13 to be pulled downward as discussed in more detail below.

FIG. 3B is a cross-sectional view which depicts the position of the pin 14 as having been pulled or extracted from pin hole 5 and through window 13 to a position in which window 13 can clear pin 14 and move downward. In this regard it is noted that while the pin 14 moves only horizontally together with the pin and cam holder assembly 26 and elongate cam element 25 discussed below, the window 13 moves vertically along an angle which is determined by the configuration of the upper portion of the window 13 that forms the weight reduction pocket 7 and lower lip 21 on the head 2 of the piston 1. This angle along which the window 13 moves up and down is determined by the desired piston configuration, controlled by guide channels 29 (discussed below) that can be provided in the sides of the windows 13 and achieved by the configuration of the cam surfaces of the cam assembly 15.

FIG. 3C is a cross-sectional view which depicts the position of the pin 14 as having been pulled or extracted from pin hole 5 and through window 13. FIG. 3C also depicts window 13 as having been moved downward so as to clear the cast piston 1 so the piston 1 can be removed from the piston mold assembly.

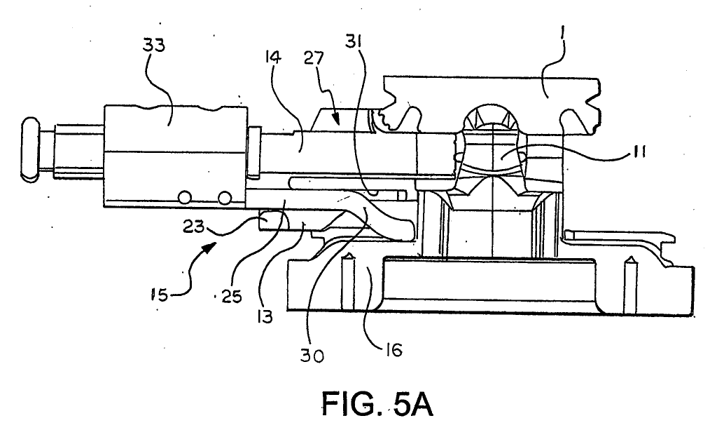

FIG. 4 is top planar view of a window structure used to form a weight reduction pocket in a piston according to one embodiment of the present invention. The window 13 includes a recess 22 that forms the peripheral lower lip 21 on the piston head 2 (See FIG. 1) and a curved protrusion 20 that forms weight reduction pocket 7 in the cast piston 1.

The window 13 depicted in FIG. 4 further includes a central cut-out 27 though which pin 14 passes. The central cut-out 27 provides clearance so that window 13 can move downward past pin 14 when pin 14 is pulled back as depicted in FIGS. 3B and 3C. The opposite sides 28 of window 13 are provided with angled guide channels 29 which can cooperate with guide projections provided on adjacent mold blocks or other suitable structure to guide the upward and downward movement of the window 13. As shown in FIG. 4 a cam follower 23 is provided on a lower outward central portion of the window 13.

FIGS. 5A-5C are a series of cross-sectional views which depict the manner in which the cam assembly cooperates to remove the pins and the windows from a mold assembly according to one embodiment of the present invention. FIG. 5A depicts the pin 14 and window 13 in their fully closed positions in the mold assembly. In the depicted position the forward end of the pin 14 engages or seats against a receiving surface provided on the core 11 as in FIG. 5A. The cam assembly 15 includes a movable elongate cam element 25 that includes a substantially linear portion that extends outward and a curved inner portion 30 that, as shown in FIGS. 5A-5C, can engage cam plate 16 and cooperate with other element surfaces to effect movement of the window 13 as discussed in detail below. The substantially linear portion of the elongate cam element 25 rides on cam follower 23 when the window 13 is in its closed or uppermost position as shown in FIGS. 5A and 5B. The window 13 includes a horizontal lower surface 31 which is beneath the cut-out 27 and opening through which pin 14 extends and passes. The elongate cam element 25 and each of the cooperating cam surfaces are axially aligned with the pin 14. In alternative embodiments pairs of the cooperating cam surfaces could be provided on opposite sides of the axial center line of the pin.

FIG. 5B is a cross-sectional view which depicts the position of the pin 14 as having been pulled or extracted from pin hole 5 and through window 13 just prior to being in a position in which window 13 can clear pin 14 and move downward. As can be seen in FIG. 5B, at the point in which the pin 11 just begins to clear window 13, the curved portion 30 of the elongate cam element 25 just begins to engage cam follower 23, so that pulling elongate cam element 25 outward further causes the cam follower 23 to be pushed down thus causing window 13 to be pushed downward. In this manner a portion of the horizontal force applied to pin 14 is converted into a vertical force that is applied to wing 13.

FIG. 5B depicts a pin and cam holder assembly 33 that holds and moves pin 14 and elongate cam element 25 horizontally. The pin and cam holder assembly 33 can be a sleeve, saddle, housing, bracket or other structured that couples the pin to the cam element 25.

FIG. 5C is a cross-sectional view which depicts the position of the pin 14 as having been pulled or extracted from pin hole 5 and through window 13. FIG. 5C also depicts window 13 as being moved downward so as to clear the cast piston 1 and thereby allowing the cast piston 1 to be removed from the mold assembly. In the position depicted in FIG. 5C the lower surface 34 of the inward end 35 of the elongate cam element 25 has slid from the surface of the horizontal portion of the cam plate 16 over the outer curved portion 36 of the cam plate 16 and the upper horizontal surface 37 of the elongate cam element 25 has moved out of contact with the horizontal lower surface 31 of the window 13.

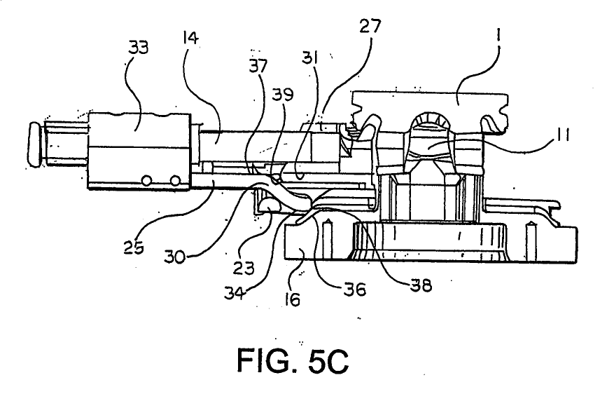

Once the pin 14 has been pulled out of the window 13 and the window 13 has moved downward so as to be release from a cast piston 1, further horizontal outward movement of the pin and cam holder assembly 33 can engage a suitable pull back plate (See FIG. 6) that will pull the mold blocks apart and release the cast piston from the piston assembly.

The process sequence depicted in FIGS. 5A-5C can be reversed to prepare the mold for a subsequent molding operation. When reversing the illustrated process beginning as depicted in FIG. 5C, as the pin and cam holder assembly 33 is moved horizontally inwardly, the leading lower edge 38 of the elongate cam element 25 slides up the curved portion 36 of the cam plate 16. As the elongate cam element 25 is moved inward the curved portion 30 of the cam element 25 slides under the outer leading edge 39 of an lower horizontal surface 31 provided on window 13. The sliding cooperation causes the window 13 to rise up guided by structural which cooperates with guide channels 29 into the position depicted in FIG. 5A. The contact between the lower leading surface 40 of the elongate cam element 25 and between the upper horizontal surface 37 of the elongate cam element 25 and the lower horizontal surface 31 of the window 13 provides for bracing the window 13 in its upward and closed position in the piston mold assembly.

Further inward movement of the pin and cam holder assembly 33 causes the pin 14 to pass through the window 13 so that the inner end of the pin 14 engages or seats against a receiving surface provided on the core 11 as shown in FIG. 5A.

The forward movement of the pin and cam holder assembly can also be used to push the mold blocks of the mold assembly together either by direct contact or any suitable pushing block arrangement. (See FIG. 6)

FIG. 6 is a top perspective view of a sectioned piston mold assembly according to one embodiment of the resent invention. The piston assembly depicted in FIG. 6 includes a pull back plate 42 that is coupled to the outer portion of the pin and cam holder assembly 33. One or both ends of the pull back plate 12 is/are slidingly coupled to a horizontal guide bar 43 that is attached to side blocks 12 of the mold assembly. A spring 44 is positioned over the horizontal guide bar 43 with one end of the spring abutting the side block 12 and the other end of the spring 44 abutting the push back plate 42

The horizontal guide bar 43 is fixed relative to the side block 12. Push back plate 42 is movable alone horizontal guide bar 43 and is prevented from passing off the outer end 45 of horizontal guide bar 43 by any suitable abutment means such as nut 46 which can be used to adjust the force applied by spring 44.

In operation, when the pin and cam holder assembly 33 is moved inward toward the center of the mold assembly, the push back plate 42 which is coupled to the pin and cam holder assembly 33 moves inward and pushes against spring 44. The force applied to spring 44 pushes side blocks 12 toward their closed position. When the pin and cam holder assembly 33, is moved to its innermost position, the resulting increased force of the spring 44 is sufficient to hold the side blocks 12 in their closed position for casting a piston.

As the pin and cam holder assembly 33 is moved outward the force of spring 44 is reduced as the push back plate 42 moves outward. Eventually as the pin and cam holder assembly 33 is moved outward, the push back plate 42 which is coupled thereto contacts and pushes against nut 46 which applies the outward force to the horizontal guide bar 43 and causes the side blocks 12 to be pulled outward.

Form the above description it can be understood how the method and means of forming weight reduction pockets above the pin holes in the outer sides of a piston can be accomplished by making rather simple machine modifications to a single cavity mold assembly.

Structural elements of the piston mold assembly can be made from conventional materials that are heat resistant. Although the above description focuses on the elements that are used to coordinate the movement of the windows and pin members, it is to be understood that when other, more conventional elements of the piston mold assembly such as the core and dome are used, these elements can be manipulated in conventional ways by conventional means that are understood to those skilled in the art.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

What is claimed is:

1. A piston mold assembly that comprises:
a base;
a core extending upward from the base for shaping an interior of a piston;
a set of mold segments that are horizontally movable with respect to the core so as to converge upon the core to define a mold cavity that forms sides of a piston;
a set of pin members that are horizontally movable with respect to the core so as to converge upon the core to form pin holes of a piston;
a set of windows which are movable upward and downward at inclined angles with respect to the core so as to form weight reduction pockets in opposite outer sides of a piston above pin hole formed in the piston; and
a cam assembly that coordinates the movement of the pin members and the windows so that after a piston is molded, downward movement of the windows is delayed until horizontal movement of the pin members has occurred.

2. A piston assembly according to claim 1, wherein the set of pin members move horizontally through openings in the windows.

3. A piston assembly according to claim 1, wherein a portion of a horizontal force applied to the pin members is directed into a vertical force by the cam assembly which vertical force is applied to the windows.

4. A piston assembly according to claim 3, wherein the cam assembly includes elongate cam elements that are movable horizontally.

5. A piston assembly according to claim 4, wherein the elongate cam elements are moved horizontally simultaneously with the pin members.

6. A piston assembly according to claim 5 further comprising a pair of horizontally movable holders to which the pin members and elongate cam elements are coupled for horizontal movement therewith.

7. A piston assembly according to claim 3, wherein lower portions of the windows are provided with cam followers and the elongate cam elements have curved portions which are configured to push against the cam followers and thereby move the windows downward as the elongate cam elements move horizontally outward with respect to the windows.

8. A piston assembly according to claim 7, wherein the lower portions of the windows include horizontal surfaces above the cam followers and the curved portions of the elongate cam elements are configured to push against the horizontal surfaces of the windows and thereby move the windows upward as the elongate cam elements move horizontally inward with respect to the windows.

9. A piston assembly according to claim 8 further including a set of cam plates that are held in a fixed position with respect to base which cam plates are configured so that inward portions of the elongate cam elements brace the windows upward against surfaces of the cam plates.

10. A piston assembly according to claim 1, wherein the windows include guide structures that guide the upward and downward movement of the windows.

11. A piston assembly according to claim 1, wherein upper portions of the windows are configured to define the shape of the weight reduction pockets.

12. A piston assembly according to claim 11, wherein upper portions of the windows are configured to define the shape of a lower lip formed on a piston head of a piston formed in the mold assembly.

13. A piston assembly according to claim 1 further comprising spring elements that urge the set of mold blocks toward each other.

14. A method of molding a piston which comprises the steps of:
a) providing a piston mold assembly that includes:
i) a base;
ii) a core extending upward from the base for shaping an interior of a piston;
iii) a set of mold segments that are horizontally movable with respect to the core so as to converge upon the core to define a mold cavity that forms sides of a piston;
iv) a set of pin members that are horizontally movable with respect to the core so as to converge upon the core to form pin holes of a piston;
v) a set of windows which are movable upward and downward at inclined angles with respect to the core so as to form weight reduction pockets in opposite sides of a piston above pin hole formed in the piston; and
vi) a cam assembly that coordinates the movement of the pin members and the windows so that after a piston is molded downward movement of the windows is delayed until horizontal movement of the pin members has occurred;
b) positioning the mold segments, pin members and windows into position in the mold assembly to produce a mold cavity;
c) delivering molten metal into the mold cavity to mold a piston therein and thereafter;
d) moving the pin members outward from the mold;
e) moving the windows downward;
f) moving the mold segments outward; and
g) removing the cast piston from the mold assembly.

15. The method of molding a piston according to claim 14, wherein step d) is performed before step e).

16. The method of molding a piston according to claim 15, wherein the pin members continue to move outward as the windows move downward.

17. The method of molding a piston according to claim 14, wherein steps d) and e) are reversed when the mold segments, pin members and windows are moved into position to produce a mold cavity.

18. The method of molding a piston according to claim 14, wherein a portion of a horizontal force applied to the pin members is directed into a vertical force by the cam assembly which vertical force is applied to the windows.

19. In a piston mold assembly configured to mold a piston therein and having a set of retractable pin members for forming pin holes in the cast piston and a set of windows for forming weight reduction pockets over the pin holes, the improvement comprising a cam assembly that coordinates horizontal movement of the pin members and upward and downward movement of the windows at inclined angles so as to form weight reduction pockets in opposite sides of the cast piston above pin holes formed in the piston.

20. The piston assembly according to claim 19, wherein the cam assembly coordinates the movement of the pin members and the windows so that after the piston is molded downward movement of the windows is delayed until horizontal movement of the pin members has occurred.
